(19) United States
(12) Patent Application Publication
(10) Pub. No.: US 2026/0140354 A1
(43) Pub. Date: May 21, 2026

(54) OPTICAL SYSTEM AND IMAGE PROJECTION APPARATUS

(71) Applicant: SAMSUNG ELECTRONICS CO., LTD., Suwon-si (KR)

(72) Inventors: Katsutoshi SASAKI, Yokohama-shi (JP); Kei NOJIMA, Yokohama-shi (JP); Osamu KONUMA, Yokohama-shi (JP); Shinwoo YOON, Suwon-si (KR); Yoomin CHOI, Suwon-si (KR)

(73) Assignee: SAMSUNG ELECTRONICS CO., LTD., Suwon-si (KR)

(21) Appl. No.: 19/395,725

(22) Filed: Nov. 20, 2025

(30) Foreign Application Priority Data
Nov. 20, 2024 (JP) 2024-202206

(51) Int. Cl. G02B 17/08; G02B 13/16; G02B 13/18; G02B 21/28; G02B 27/09

(52) U.S. Cl. CPC G02B 17/0856; G02B 13/16; G02B 13/18; G02B 21/28; G02B 27/0972

(57) ABSTRACT

Provided is an optical system including an image display element, a first optical system including a plurality of lenses, and a second optical system including an optical element including a transmission surface and a reflection surface, the first optical system is configured to form an intermediate image from an image that is output from an image display element and passed through the first optical system, and wherein the second optical system is configured to form an enlarged image of the intermediate image on a projection surface which is a conjugate plane of the image display element, the transmission surface of the optical element comprising a first transmission surface and a second transmission surface, wherein the reflection surface includes a first reflection surface and a second reflection surface, wherein the first transmission surface, the first reflection surface, the second reflection surface, and the second transmission surface are provided in that order.

### CROSS-REFERENCE TO RELATED APPLICATION(S)

This application is based on and claims priority under 35 U.S.C. § 119 to Japanese Patent Application No. 2024-202206, filed on Nov. 20, 2024, in the Japanese Patent Office, the disclosure of which is incorporated by reference herein in its entirety.

### BACKGROUND

### 1. Field

The present disclosure relates to an ultra-short focus projection optical system capable of projecting an image or the like onto a screen with a short projection distance, and a projector using such an optical system.

### 2. Description of Related Art

For ultra-short focus projection optical systems capable of projecting an image or the like onto a projection surface such as a screen with a short projection distance, a reflection-and-refraction optical system including a refraction optical system and a reflection optical system may be used.

For example, in the related art, there exists a projection optical system of a reflection-and-refraction optical system formed of two mirrors, a reflection-and-refraction optical system including a reflecting mirror and a prism, and a reflection-and-refraction optical system including a prism having a plurality of transmission surfaces and a plurality of reflection surfaces.

### SUMMARY

Provided is an optical system and an image projection apparatus that may improve an accuracy of adjustment.

According to an aspect of the disclosure, there is provided an optical system including an image display element, a first optical system including a plurality of lenses, and a second optical system including an optical element including a transmission surface and a reflection surface, wherein the first optical system is configured to form an intermediate image from an image that is output from an image display element and passed through the first optical system, and wherein the second optical system is configured to form an enlarged image of the intermediate image on a projection surface which is a conjugate plane of the image display element, the transmission surface of the optical element comprising a first transmission surface and a second transmission surface, wherein the reflection surface includes a first reflection surface and a second reflection surface, wherein the first transmission surface, the first reflection surface, the second reflection surface, and the second transmission surface are provided in an order in which light of the image from the first optical system is configured to pass through, wherein an optical path between two adjacent surfaces of the first transmission surface, the first reflection surface, the second reflection surface, and the second transmission surface is formed of an optically transparent medium, and wherein the second reflection surface has a concave shape.

The first reflection surface and the second transmission surface may be connected to each other.

The first reflection surface and the second transmission surface may form a continuous surface, and a first reflection surface area and a second reflection area may be separated, the first reflection surface area corresponding to a light-beam effective area of the first reflection surface and including a reflecting film, and the second transmission surface area corresponding to a light-beam effective area of the second transmission surface.

The first reflection surface may have a planar shape.

The first transmission surface may include a rotationally symmetric surface which is rotationally symmetric with respect to a first optical axis, the first optical axis being an optical axis of the first optical system.

The first reflection surface may be configured to bend an optical axis of the first optical system by 90°.

The second reflection surface and the second transmission surface may include a rotationally symmetric surface which is rotationally symmetric with respect to a second optical axis obtained by bending an optical axis of the first optical system by 90°.

The intermediate image may be configured to be formed in an optical path between the first reflection surface and the second reflection surface.

According to an aspect of the disclosure, there is provided an image projection apparatus including an optical system including, an image display element, a first optical system including a plurality of lenses, and a second optical system including an optical element including a transmission surface and a reflection surface, wherein the first optical system is configured to form an intermediate image from an image that is output from an image display element and passed through the first optical system, and wherein the second optical system is configured to form an enlarged image of the intermediate image on a projection surface which is a conjugate plane of the image display element, the transmission surface of the optical element comprising a first transmission surface and a second transmission surface, wherein the reflection surface includes a first reflection surface and a second reflection surface, wherein the first transmission surface, the first reflection surface, the second reflection surface, and the second transmission surface are provided in an order in which light of the image from the first optical system is configured to pass through, wherein an optical path between two adjacent surfaces of the first transmission surface, the first reflection surface, the second reflection surface, and the second transmission surface is formed of an optically transparent medium, and wherein the second reflection surface has a concave shape.

The first reflection surface and the second transmission surface may be connected to each other.

The first reflection surface and the second transmission surface may form a continuous surface, and a first reflection surface area and a second reflection area may be separated, the first reflection surface area corresponding to a light-beam effective area of the first reflection surface and including a reflecting film, and the second transmission surface area corresponding to a light-beam effective area of the second transmission surface.

The first reflection surface may have a planar shape.

The first transmission surface may include a rotationally symmetric surface which is rotationally symmetric with respect to a first optical axis, the first optical axis being an optical axis of the first optical system.

The first reflection surface may be configured to bend an optical axis of the first optical system by 90°.

The second reflection surface and the second transmission surface may include a rotationally symmetric surface which is rotationally symmetric with respect to a second optical axis obtained by bending an optical axis of the first optical system by 90°.

The intermediate image may be configured to be formed in an optical path between the first reflection surface and the second reflection surface.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a cross-sectional view showing an example of an optical system according to an embodiment;

FIG. 2 is a cross-sectional view showing an example of an image projection apparatus in FIG. 1;

FIG. 3 is a cross-sectional view showing an example of an optical element in a second optical system in FIG. 1;

FIG. 4 is a cross-sectional view showing an example of lens data of the optical system in FIG. 1;

FIG. 5 is a cross-sectional view showing an example of lens data of the optical system in FIG. 1;

FIG. 6 is a cross-sectional view showing an example of lens data of the optical system in FIG. 1;

FIG. 7 is a graph showing examples of MTF performance of the optical system in FIG. 1, in which the horizontal axis indicates the spatial frequency and the vertical axis indicates the MTF performance;

FIG. 8 is a cross-sectional view showing an example of an optical system according to another embodiment;

FIG. 9 is a cross-sectional view showing an example of an optical element in a second optical system in FIG. 8;

FIG. 10 shows an example of lens data of the optical system in FIG. 8;

FIG. 11 shows an example of lens data of the optical system in FIG. 8;

FIG. 12 shows an example of lens data of the optical system in FIG. 8;

FIG. 13 is a cross-sectional view showing an example of the optical system in FIG. 8;

FIG. 14 is a cross-sectional view showing an example of an optical element in a second optical system according to an embodiment;

FIG. 15 shows an example of lens data of an optical system in FIG. 14;

FIG. 16 shows an example of lens data of the optical system in FIG. 14;

FIG. 17 is a graph showing an example of MTF performance of the optical system in FIG. 14, in which the horizontal axis indicates the spatial frequency and the vertical axis indicates the MTF performance;

FIG. 18 is a cross-sectional view showing an example of an optical system according to another embodiment;

FIG. 19 is a cross-sectional view showing an example of an optical element in a second optical system in FIG. 18;

FIG. 20 shows an example of lens data of an optical system in FIG. 18; and

FIG. 21 shows an example of lens data of the optical system in FIG. 18.

### DETAILED DESCRIPTION

For clarity of explanation, the following descriptions and drawings are omitted and simplified as appropriate. Further, in the drawings, hatching and the like may be omitted even in a cross section when they make the drawing complicated instead of making it clearer or when it is clearly distinguished from a void. Note that the same reference numerals are assigned to the same elements throughout the drawings, and redundant descriptions thereof are omitted as appropriate. Some reference numerals may be omitted to prevent the drawing from becoming complicated.

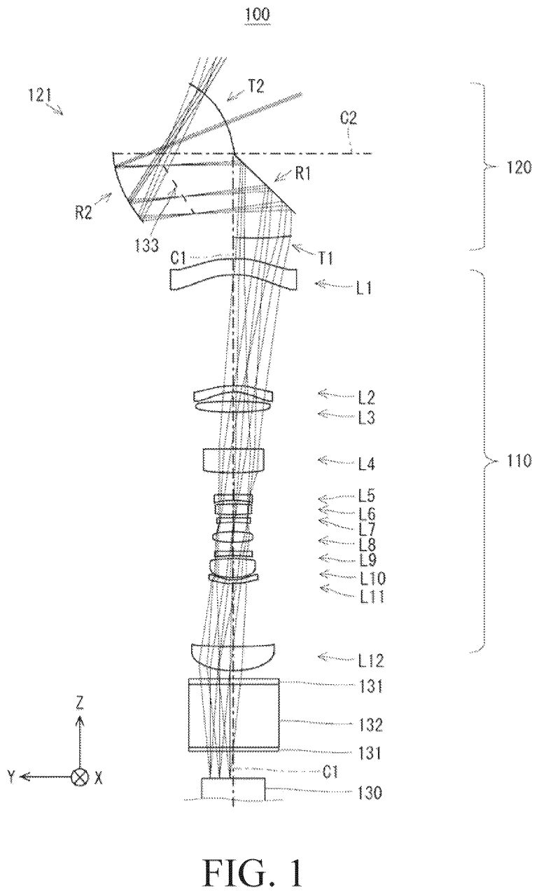

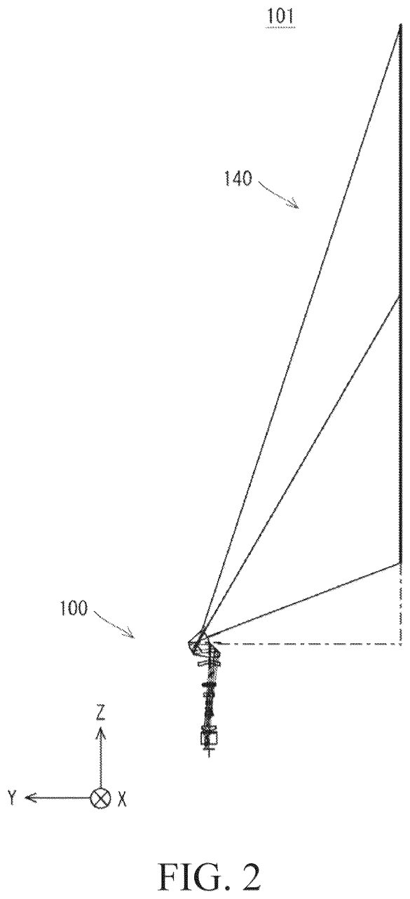

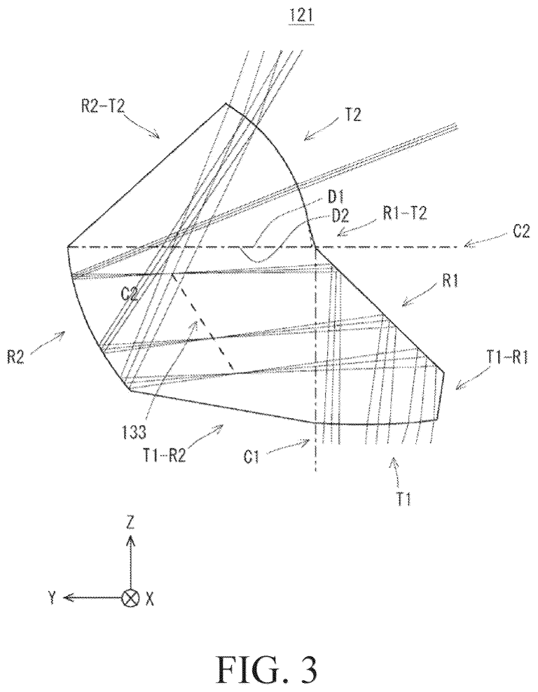

An overview of an optical system and an image projection apparatus according to an embodiment will be described. FIG. 1 is a cross-sectional view showing an example of an optical system 100 according to an embodiment. FIG. 2 is a cross-sectional view showing an example of an image projection apparatus 101 in FIG. 1. FIG. 3 is a cross-sectional view showing an example of an optical element 121 in a second optical system 120 in FIG. 1. In FIG. 1, the medium is not shown in order to show an optical cross-sectional view of the second optical system 120.

The optical system 100 and the image projection apparatus 101 according to FIG. 1 are a projection optical system which includes a first optical system 110 and a second optical system 120, and is capable of projecting an image or the like with a relatively short projection distance. The second optical system 120 has an optical axis C1 which is common to the optical axis C1 of the first optical system 110, which is a refraction optical system, and another optical axis C2 which is an optical axis after the light bends at the reflection surface. Each surface of the optical element 121, such as a prism, constituting the second optical system 120 is characterized in that it is formed by a rotationally symmetric surface with respect to the optical axes C1 and C2. In this way, it is possible to improve the assembling and adjustment of the optical system 100.

For example, the optical element 121 includes a first transmission surface T1, a first reflection surface R1, a second reflection surface R2, and a second transmission surface T2. The first transmission surface T1 may include a rotationally symmetric surface having an optical axis C1 which is common to the optical axis C1 of the first optical system 110. The first reflection surface R1 includes a surface for bending the optical axis C1 by 90°. The second reflection surface R2 has a concave shape in a projection surface side and includes a rotationally symmetric surface having one optical axis C2. The second transmission surface T2 has a convex shape in the projection surface side and includes a rotationally symmetric surface having another optical axis C2. As described above, the second optical system 120 can be integrally formed as one optical element 121 including a transmission surface and a reflection surface, instead of being formed by a plurality of optical elements. Further, by integrally forming the second optical system 120 as one optical element 121, the accuracy of the alignment (or positioning) of the surfaces may be easily improved. The optical system 100 and the image projection apparatus 101 according to FIG. 1 will be described hereinafter in detail.

As shown in FIGS. 1 to 3, the optical system 100 includes a first optical system 110 and a second optical system 120. The optical system 100 forms an enlarged image of an image output from an image display element 130 on a projection surface 140, which is a conjugate surface of the image display element 130, through the first and second optical systems 110 and 120. The projection surface 140 (i.e., the surface 140 onto which the image is projected) is, for example, a screen. The projection surface 140 is not limited to screens, and instead may be any of wall surfaces, ground surfaces, water surfaces, and the like. The optical system 100 may further include a cover glass 131 and a prism 132 between the image display element 130 and the first optical system 110. The cover glass 131 may be disposed between the prism 132 and the image display device 130. In addition, or alternatively, the cover glass 131 may be provided between the prism 132 and the first optical system 110.

Here, an XYZ-orthogonal coordinate axis system is introduced to explain the optical system 100. For example, a direction in which the optical axis C1 of the first optical system 110 extends is defined as a Z axis direction. The +Z axis direction may be called upward, and the −Z axis direction may be called downward. However, the upward and downward do not indicate the directions in which the optical system 100 is actually disposed.

The first optical system 110 is a refraction optical system including a plurality of lenses. The first optical system 110 may include lenses L1 to L12. The first optical system 110 may be a refraction optical system composed of a plurality of lenses. The first optical system 110 may be composed of 12 refractive lenses consisting of lenses L1 to L12. However, this is merely an example and is not intended to be limiting. The first optical system 110 may include a greater number of lenses, or may include a smaller number of lenses than those illustrated in FIG. 1. The lenses L1 to L12 are arranged in this order in the +Z axis direction. The first optical system 110 has an optical axis C1.

The light of the image output from the image display element 130 travels, for example, so as to have a component in the +Z axis direction. The light of the image displayed on the image display element 130 enters the lens closest to the image display element 13 (e.g., L12) through the prism 132. The light, which have entered the lens L12, exits from the lens L1 through the lenses L11 to L1. The light of the image, which has exited from the lens L1, enters the second optical system 120.

The second optical system 120 includes one optical element 121 having transmission surfaces T1 and T2 and reflection surfaces R1 and R2. The second optical system 120 may be composed of one optical element 121 having transmission surfaces T1 and T2 and reflection surfaces R1 and R2. The optical element 121 in the second optical system 120 includes a first transmission surface T1, a first reflection surface R1, a second reflection surface R2, and a second transmission surface T2. The optical element 121 in the second optical system 120 may be composed of the first transmission surface T1, the first reflection surface R1, the second reflection surface R2, and the second transmission surface T2. In the second optical system 120, the first transmission surface T1, the first reflection surface R1, the second reflection surface R2, and the second transmission surface T2 are arranged in the order in which the light of the image from the first optical system 110 passes through. The optical path between any two adjacent of the surfaces, which include the first reflection surface R1, the second reflection surface R2, and the second transmission surface T2, of the second optical system 120 may be formed of one optically transparent medium. Examples of optically transparent medium may include at least one of glass and a transparent resin.

The first transmission surface T1 may face in the −Z axis direction. The light output from the lens L1 in the first optical system 110 is incident on the first transmission surface T1. The first transmission surface T1 may include a rotationally symmetric surface which is rotationally symmetric with respect to the optical axis C1 of the first optical system 110. For example, the first transmission surface T1 may be a curved surface which is formed as the shape of the curve of the first transmission surface T1 shown in the cross-sectional view in FIG. 3 is rotated 180° from the −X axis direction side to the +X axis direction side with the optical axis C1 being the rotation axis. For example, the shape of the curve of the first transmission surface T1 shown in the cross-sectional view in FIG. 3 is a function of the radius from the optical axis C1. Further, the shape of the first transmission surface T1 at an arbitrary position is also a function of the radius from the optical axis C1.

The first transmission surface T1 has a convex shape toward a side from which the light enters. The first transmission surface T1 may have an aspherical shape. The light that has passed through the first transmission surface T1 is incident on the first reflection surface R1.

The first reflection surface R1 reflects light incident through the first transmission surface T1 toward the second reflection surface R2. The first reflection surface R1 is formed so as to bend the optical axis C1 of the first optical system 110 by 90°. That is, the first reflection surface R1 has a function of bending the optical axis C1 of the first optical system 110 by 90°. The direction in which the optical axis C1 is reflected by the first reflection surface R1 is called an optical axis C2. Then, the optical axes C1 and C2 are orthogonal to each other. Further, the optical axes C1 and C2 intersect each other on the first reflection surface R1.

The first reflection surface R1 may have a roughly planar shape. The roughly planar shape indicates that the first reflection surface R1 has a planar shape within a range including unavoidable errors that could occur in the manufacturing thereof. The light reflected by the first reflection surface R1 is incident on the second reflection surface R2. An intermediate image 133 may be formed in an optical path between the first and second reflection surfaces R1 and R2. Therefore, the optical system 100 forms an image of the image displayed on the image display element 130 by the first optical system 110 as an intermediate image 133, and form an enlarged image of the intermediate image 133 on the projection surface 140 by the second optical system 120. An image output from the image display element 130, passing through first optical system 110 and reaching the second optical system 120, is formed as an intermediate image 133 at the second optical system 120, and the intermediate image 133 is enlarged by the second optical system 120 and formed at the projection surface 140.

The second reflection surface R2 reflects the incident light toward the second transmission surface T2. The second reflection surface R2 may include a rotationally symmetric surface with respect to the optical axis C2 obtained by bending the optical axis C1 of the first optical system 110 by 90°. For example, the second reflection surface R2 may be a curved surface which is formed as the shape of the curve of the second reflection surface R2 shown in the cross-sectional view in FIG. 3 is rotated 180°from the-X axis direction side to the +X axis direction side with the optical axis C2 being the rotation axis. That is, the shape of the curve of the second reflection surface R2 shown in the cross-sectional view in FIG. 3 is a function of the radius from the optical axis C2. Further, the shape of the second reflection surface R2 at an arbitrary position is also a function of the radius from the optical axis C2.

The second reflection surface R2 has a concave shape in the projection surface side. Specifically, the surface on which the incident light is reflected has a concave shape. The second reflection surface R2 may have an aspherical shape. The light reflected by the second reflection surface R2 is incident on the second transmission surface T2.

The second transmission surface T2 lets the incident light pass therethrough toward the projection surface 140 so as to project the incident light onto the projection surface 140. The second transmission surface T2 may include a rotationally symmetric surface with respect to the optical axis C2. The second transmission surface T2 may be a curved surface which is formed as the shape of the curve of the second transmission surface T2 shown in the cross-sectional view in FIG. 3 is rotated 180° from the −X axis direction side to the +X axis direction side with the optical axis C2 being the rotation axis. That is, the shape of the curve of the second transmission surface T2 shown in the cross-sectional view in FIG. 3 is a function of the radius from the optical axis C2. Further, the shape of the second transmission surface T2 at an arbitrary position is also a function of the radius from the optical axis C2.

The second transmission surface T2 has a convex shape in the projection surface side. The second transmission surface T2 may have an aspherical shape. The light that has passed through the second transmission surface T2 is projected onto the projection surface 40.

The first reflection surface R1 and the second transmission surface T2 may be formed by one continuous surface. The first reflection surface R1 and the second transmission surface T2 may be formed by one surface in which they are connected to each other outside the light-beam effective area. A first reflection surface area which satisfies the light-beam effective area of the first reflection surface R1 and in which a reflecting film is provided, and a second transmission surface area which satisfies the light-beam effective area of the second transmission surface T2 may be separately formed.

The first reflection surface R1 and the second transmission surface T2 may be seamlessly connected to each other. That is, the first reflection surface R1 and the second transmission surface T2 may be connected to each other so that no step is formed therein. In this way, it is possible to facilitate the manufacturing, and thereby to reduce the cost. Note that the present disclosure does not exclude cases where a step is formed between the first reflection surface R1 and the second transmission surface T2.

In the cross-sectional view in FIG. 3, although it is shown that the first reflection surface R1 and the second transmission surface T2 are connected to each other at an obtuse angle for the convenience, it is possible to connect the first reflection surface R1 and the second transmission surface T2 to each other by appropriately extrapolating the surface curvature outside the light-beam effective area according to the shape of the processing tool of the surface processing manufacturing apparatus. For example, an optical path length D1 of the optical axis C2 reflected by the first reflection surface R1 to the second reflection surface R2 and an optical path length D2 of the optical axis C2 reflected by the second reflection surface R2 to the second transmission surface T2 are roughly equal to each other. When the optical path lengths D1 and D2 are not roughly equal to each other, a step is formed in the connection surface between the first reflection surface R1 and the second transmission surface T2. Therefore, the first reflection surface R1 and the second transmission surface T2 may not become one continuous surface. FIG. 2 shows that the first reflection surface R1 and the second transmission surface T2 are seamlessly and continuously connected to each other.

The surface between the first reflection surface R1 and the second transmission surface T2 may be referred to as a connection surface R1-T2. The surface between the first reflection surface R1 and the first transmission surface T1 may be called a connection surface T1-R1. The surface between the first transmission surface T1 and the second reflection surface R2 may be called a connection surface T1-R2. The surface between the second reflection surface R2 and the second transmission surface T2 may be called a connection surface R2-T2. Each connection surface may be planar or curved. Further, each connection surface may be a surface with a step. By adopting such a shape, attaching the optical element 121 to a mechanism member for holding it is facilitated. Further, each connection surface can be deformed in consideration of the molding manufacturing process.

In this embodiment, the optical element 121 in the second optical system 120 may be surrounded by four surfaces including the first transmission surface T1, the first reflection surface R1, the second reflection surface R2, and the second transmission surface T2. The optical element 121 may be provided as one element of which the inside is filled with a medium. In this way, it is possible to mold it into an appropriate shape, thus providing advantages in the mass-production and the surface eccentricity accuracy management.

For example where the first reflection surface R1 and the second transmission surface T2 are formed by one surface, it is preferred that the optical axes C1 and C2 of the first reflection surface R1 are formed so as to remain on the first reflection surface R1. As a result, since the optical axes C1 and C2 are present in the optical element 121 of the second optical system 120, it is possible to easily ensure the accuracy of the assembling and adjustment of the first optical system 110 and the projection surface 40.

In this embodiment, the first reflection surface R1 has a planar shape. The second reflection surface R2 has a concave shape in the projection surface side. The projection surface side may be referred to as “the enlargement side.” The second transmission surface T2 has a convex shape in the projection surface side. An intermediate image 133, which is conjugate with an image displayed on the image display surface of the image display element 130 and an image displayed on the projection surface, is formed between the first and second reflection surfaces R1 and R2. The second reflection surface R2 has a concave shape as a reflection surface having a function of projecting the intermediate image 133 onto the projection surface 140 such as a screen in an enlarged manner.

Further, the second optical system 120 includes the first transmission surface T1, the second reflection surface R2, and the second transmission surface T2, which have optical power, in the vicinity of and in front of and behind the intermediate image 133, so that it is possible to project an image or the like with a short projection distance while ensuring optical image-forming performance. By this optical power arrangement, it is possible to configure the optical system so that an optical pupil is provided between the second reflection surface R2 and the second transmission surface T2, so that the light-beam effective area on the second transmission surface T2 may be reduced. Further, the boundary between the first reflection surface R1 and the second transmission surface T2 may be separated without overlapping with the light-beam effective area of the first reflection surface R1 formed as a continuous surface.

The first transmission surface T1 has an aspherical shape in which the curvature in the central part is different from that in the peripheral part so that it is optimized for the off-axis aberration correction together with an aspherical lens located at a position closest to the second optical system 120 of the first optical system 110. Further, the optical axis C2 is formed by bending the optical axis C1 of the first optical system 110 by 90° by the first reflection surface R1, so that, as a result, the image display surface of the image display element 130 and the projection surface 140 such as a screen can be configured in a perpendicular relationship. For example, the projection surface 140 such as a screen and the optical axis C1 of the first optical system 110 can be configured in a parallel relationship. Therefore, the footprint of the installation of the image projection apparatus 101 including the optical system 100 may be minimized, and the usability for users, such as the degree of freedom in regard to the installation environment, may be improved.

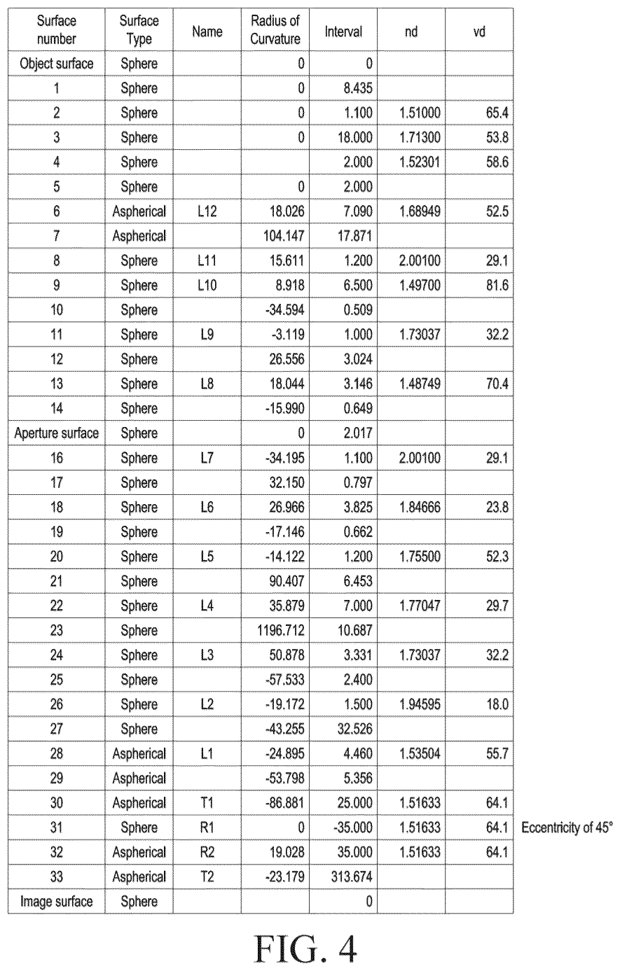

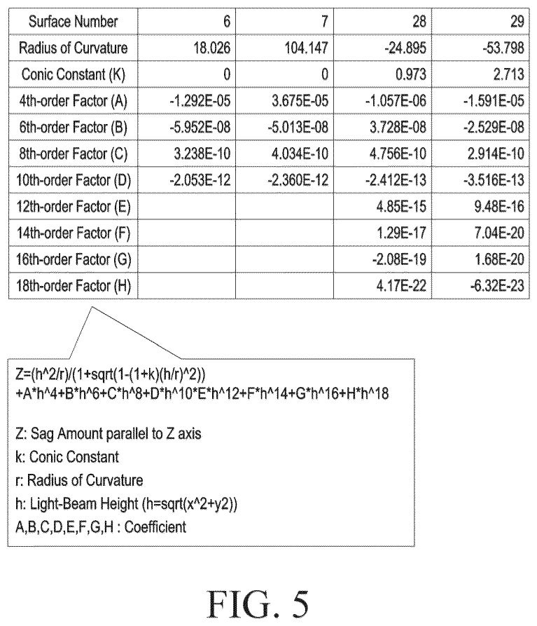

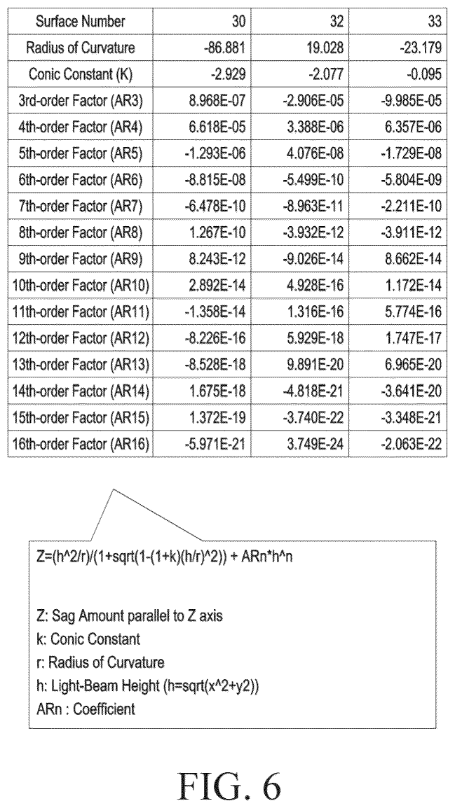

FIGS. 4 to 6 show examples of lens data of the optical system 100 in FIG. 1. FIG. 4 shows a surface type, a name, a radius of curvature, an interval, nd (refractive index of d-line), and νd (Abbe number) for the surface of each of optical members indicated by surface numbers from the object surface, which is the image display surface of the image display element 130, to the image surface, which is the projection surface 140. FIGS. 5 and 6 show design data of the aspheric surface of each of optical members indicated by surface numbers. FIGS. 5 and 6 also show aspherical types. The specification is Fno3.0, 70″ projection, and the size of the object surface is 5.8 mm×10.4 mm, and shifted from the center of the object surface by 3.79 mm.

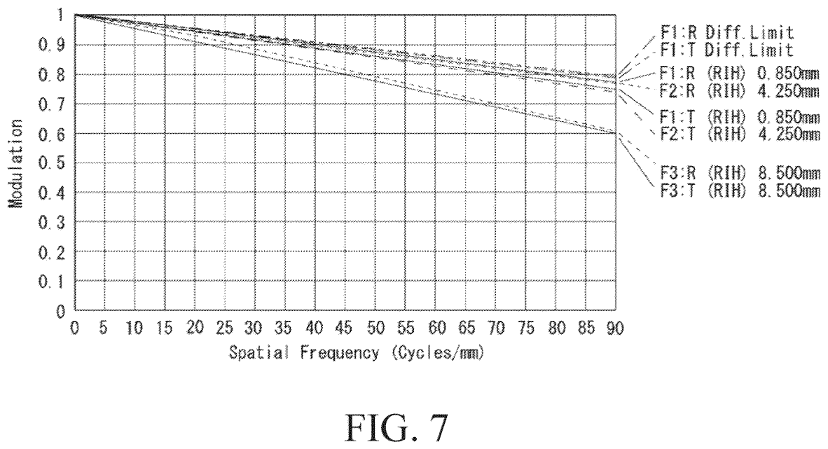

FIG. 7 is a graph showing examples of MTF (Modulation Transfer Function) performance of the optical system 100 in FIG. 1, in which the horizontal axis indicates the spatial frequency and the vertical axis indicates the MTF performance. As shown in FIG. 7, the spatial frequency of 90 lines/mm corresponds to the unit pixel of 5.6 μm of the image display element 130. The evaluation image heights are Field1(F1): Y=0.85 mm, Field2(F2): Y=4.25 mm, and Field3(F3): Y=8.5 mm on the image display element. The evaluation wavelengths and weights are 643 nm:525 nm:440 nm=1:1:1. As shown in FIG. 7, the optical system 100 according to this embodiment ensures MTF performance of 0.6 or higher.

According to this embodiment, since the optical system 100 includes the first and second optical systems 110 and 120 as described above, it is possible to provide an ultra-short focus projection optical system capable of projecting an image or the like with a short projection distance. The optical element 121, which constitutes the second optical system 120, is formed as one optical element 121 having a transmission surface and a reflection surface, instead of being formed by a plurality of optical elements. Therefore, it is possible to project an image or the like with a short projection distance while ensuring optical performance. Further, by configuring the optical element as one having optical axes C1 and C2 on each surface, it is possible to improve the accuracy of the alignment (or positioning) of the surfaces.

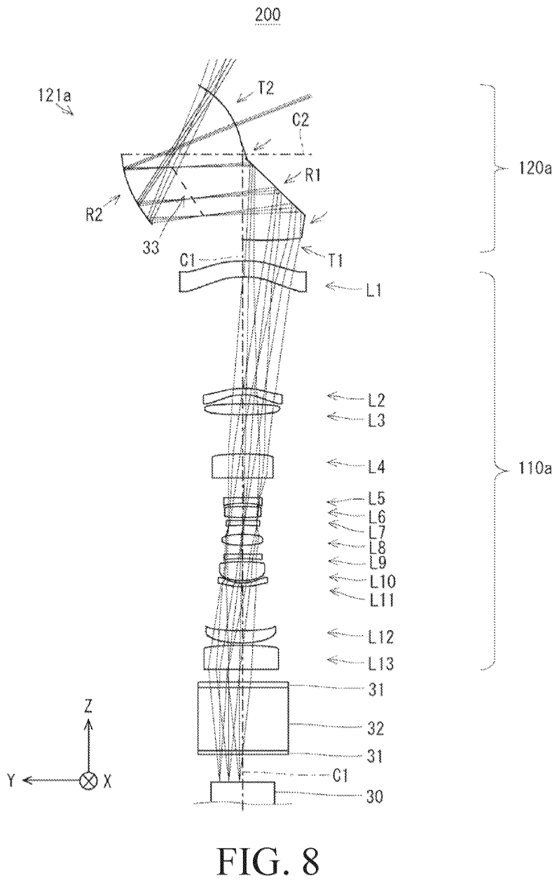

Next, an optical system according to another embodiment will be described. This embodiment corresponds to a modified configuration of the first optical system 110 in the optical system 100 in FIG. 1 described above. Further, it also corresponds to a modified configuration of the second optical system 120 in the optical system 100 in FIG. 1. FIG. 8 is a cross-sectional view showing an example of an optical system 200 according to the second embodiment. As shown in FIG. 8, a first optical system 110a according to this embodiment includes lenses L1 to L13. The lens L1 is composed of an aspherical lens. Further, the first optical system 110a further includes the lens L13. The rest of the configuration of the first optical system 110a is the same as that of the first optical system 110 described above.

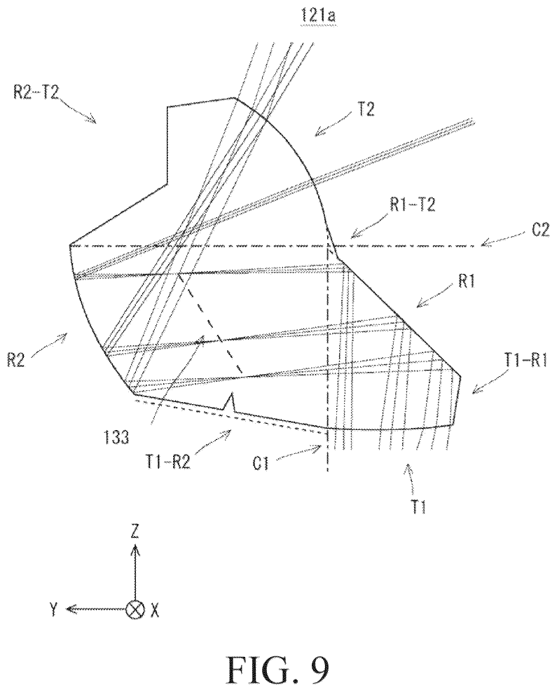

FIG. 9 is a cross-sectional view showing an example of an optical element 121a in a second optical system 120a according to the embodiment of FIG. 8. As shown in FIG. 9, in the second optical system 120a according to this embodiment, each of connection surfaces T1-R1, T1-R2, R2-T2, and R1-T2 may be planar or curved. Further, each connection surface may be a surface with a step or an inclined surface. Further, each connection surface may be deformed in consideration of attaching of mechanism members for holding optical components including the optical system 200, or may be deformed in consideration of manufacturing of optical components including the optical system 200 through a molding process.

Further, each connection surface may be a sanded surface or a black-painted surface. Further, a V-shaped groove may be formed in each connection surface. By adopting such a configuration, it is possible to avoid a problem that would otherwise occur as unnecessary light enters an optical component of the optical system 200, is reflected at each connection surface or the like, and becomes ghost light on the projection surface.

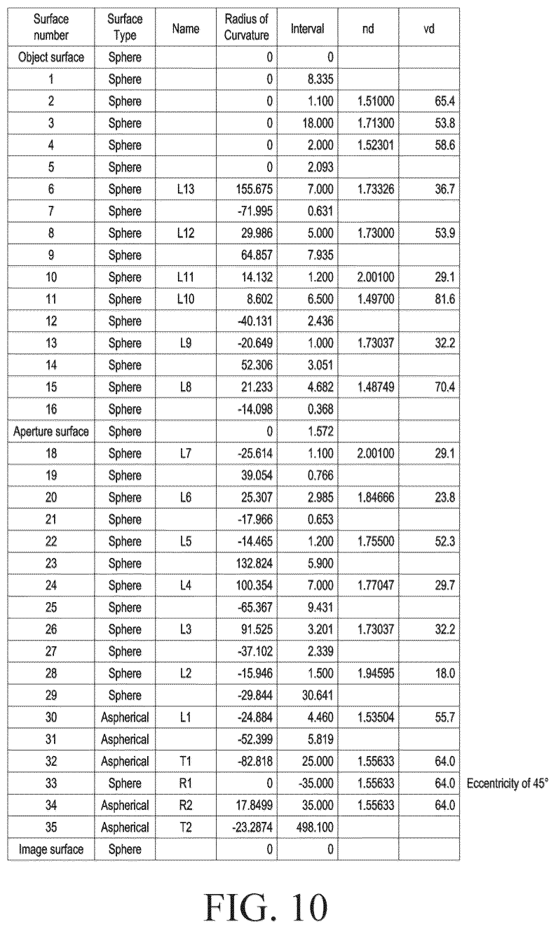

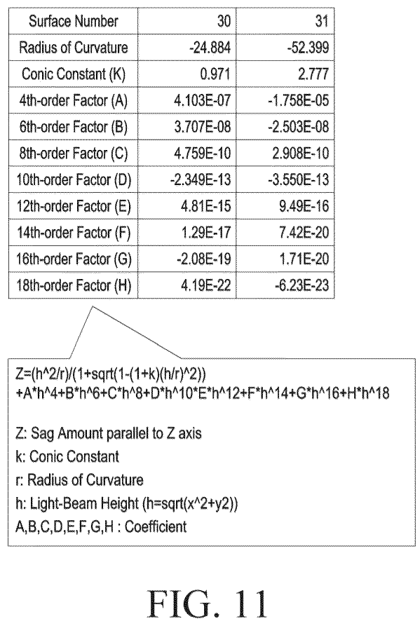

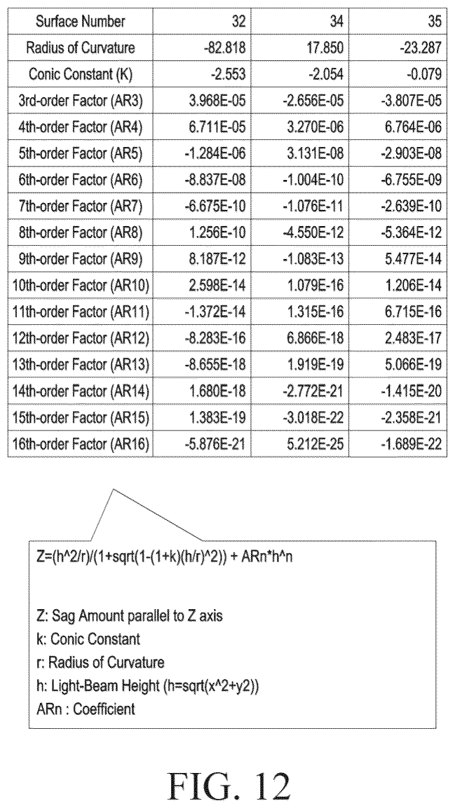

FIGS. 10 to 12 show examples of lens data of the optical system 200 in FIG. 8. FIG. 10 shows a surface type, a name, a radius of curvature, an interval, nd, and νd for the surface of each of optical members indicated by surface numbers from the object surface, which is the image display surface of the image display element 130, to the image surface, which is the projection surface 140. FIGS. 11 and 12 show design data of the aspheric surface of each of optical members indicated by surface numbers. The specification is different from the specification of the embodiment in FIG. 1 in that it is Fno3.0, 100″ projection. The size of the object surface is 5.8 mm×10.4 mm, and is shifted from the center of the object surface by 3.79 mm.

According to this embodiment, the degree of freedom in regard to the design of the optical element 121a in the second optical system 120a can be improved. The rest of the configuration and effects have already been described in the descriptions of the first embodiment.

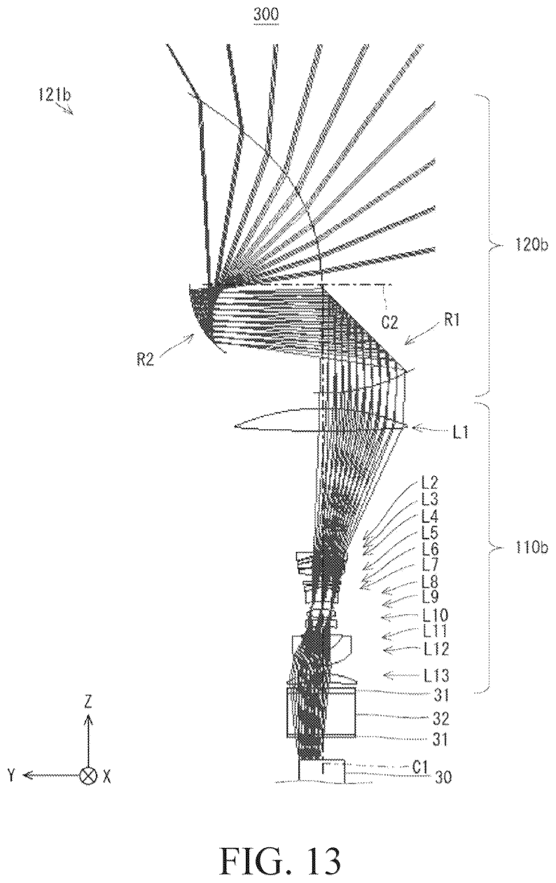

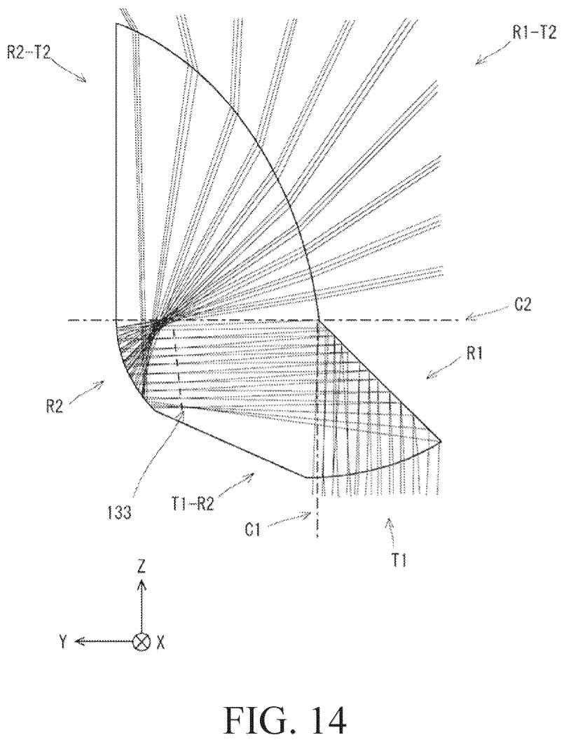

Next, an optical system according to another embodiment will be described. This embodiment is an example in which an ultra-wide-angle projection optical system is formed is formed. FIG. 13 is a cross-sectional view showing an example of an optical system 300 according to the third embodiment. FIG. 14 is a cross-sectional view showing an example of an optical element 121b in a second optical system 120b according to the third embodiment. In FIGS. 13 and 14, as an angle of view, projected light beams from 11° to 120° are shown.

As shown in FIGS. 13 and 14, the optical system 300 includes a first optical system 110b and a second optical system 120b. The configuration of a first transmission surface T1, a first reflection surface R1, a second reflection surface R2, and a second transmission surface T2 in the second optical system 120b may be the same as that in the first embodiment. However, the second optical system 120b in FIG. 13 has a feature, in particular, in the second transmission surface T2. That is, the exit pupil of the second optical system 120b is positioned at a position shorter than the focal point of the second transmission surface T2. As a result, the second transmission surface T2 becomes a surface that acts in a direction in which the light beams of respective angles of view are expanded. With such a configuration, the second optical system 120b can perform ultra-wide-angle projection. Although the connection surface T1-R1 between the first transmission surface T1 and the first reflection surface R1 is not shown in the drawing, the first transmission surface T1 and the first reflection surface R1 may be extended and connected to each other, or may be connected to each other by a planar surface or a curved surface.

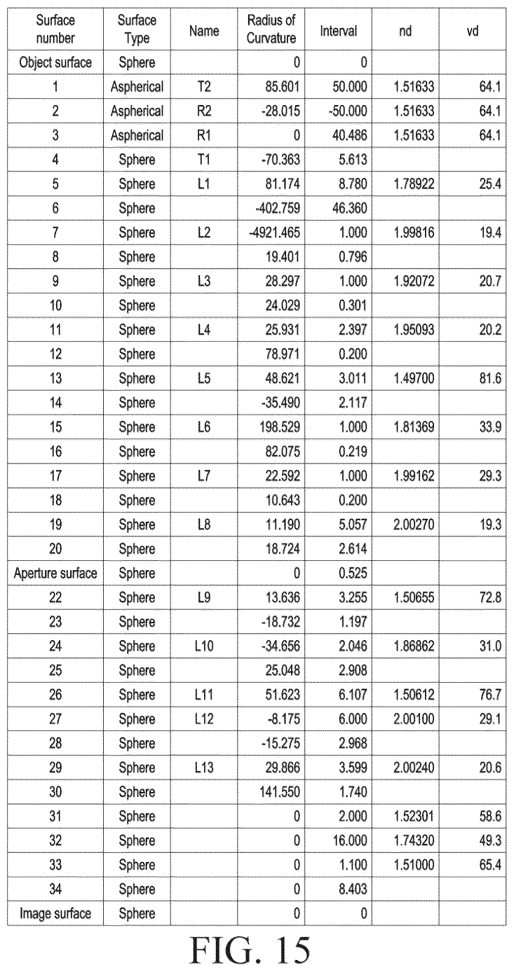

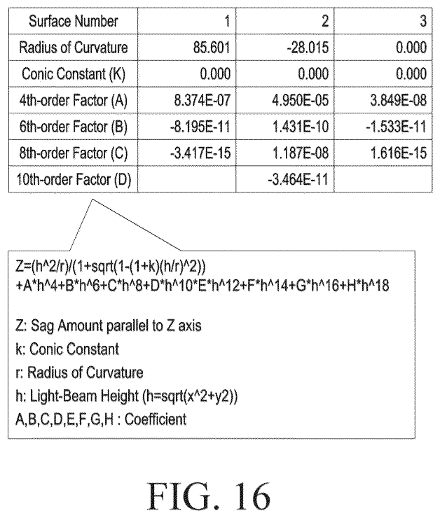

FIGS. 15 and 16 show examples of lens data of the optical system 300 according in FIG. 13. FIG. 15 shows a surface type, a name, a radius of curvature, an interval, nd, and vd for the surface of each of optical members indicated by surface numbers from the image surface, which is the image display surface of the image display element 130, to the object surface, which is the projection surface 140. FIG. 16 shows design data of the aspheric surface of each of optical members indicated by surface numbers. The specification is different from the embodiments above in that it is Fno 3.0, whole angle of view maximum 240° projection. The size of the object surface is 5.8 mm×10.4 mm, and is shifted from the center of the object surface by 3.79 mm.

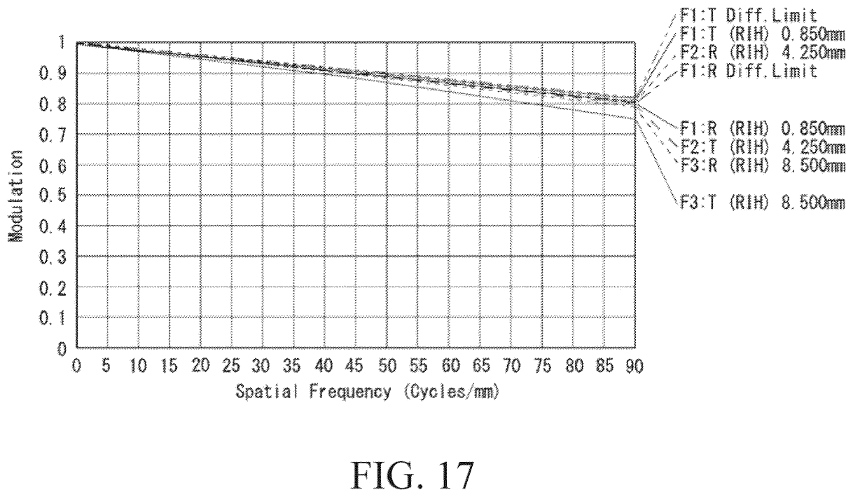

FIG. 17 is a graph showing an example of MTF performance of the optical system 300 in FIG. 13, in which the horizontal axis indicates the spatial frequency and the vertical axis indicates the MTF performance. As shown in FIG. 17, the spatial frequency of 90 lines/mm corresponds to the unit pixel of 5.6 μm of the image display element 130. The evaluation image heights are Field1(F1): Y=0.84 mm, Field2(F2): Y=4.2 mm, and Field3(F3): Y=8.4 mm on the image display element. When it is converted into the angle of view, these values are equivalent to Field 1(F1): 11°, Field 2(F2): 55°, and Field 3(F3): 110°. The evaluation wavelengths and weights are 643 nm:525 nm:440 nm=1:1:1. As shown in FIG. 17, the optical system 300 according to this embodiment ensures MTF performance of 0.7 or higher.

The optical system 300 of the ultra-wide-angle projection optical system may be provided. The rest of the configuration and effects have already been described in the descriptions of the first and second embodiments.

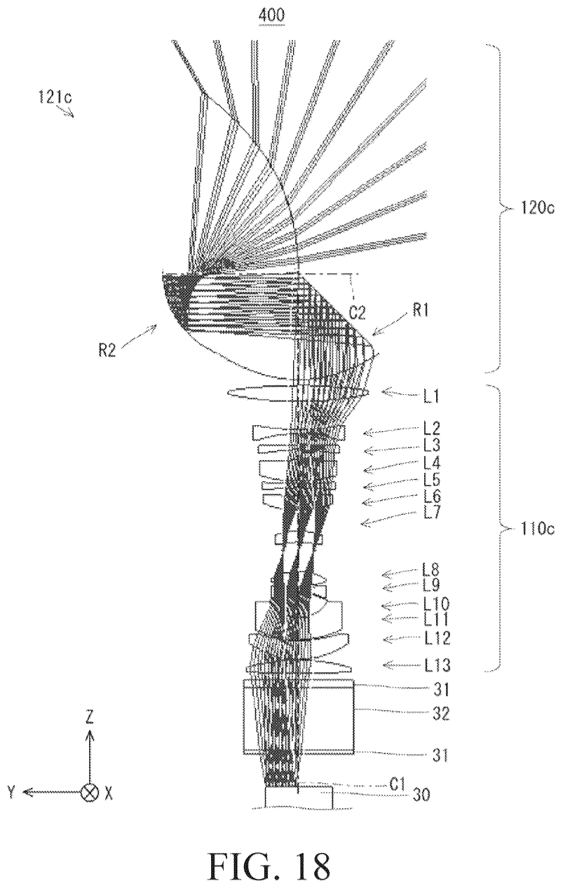

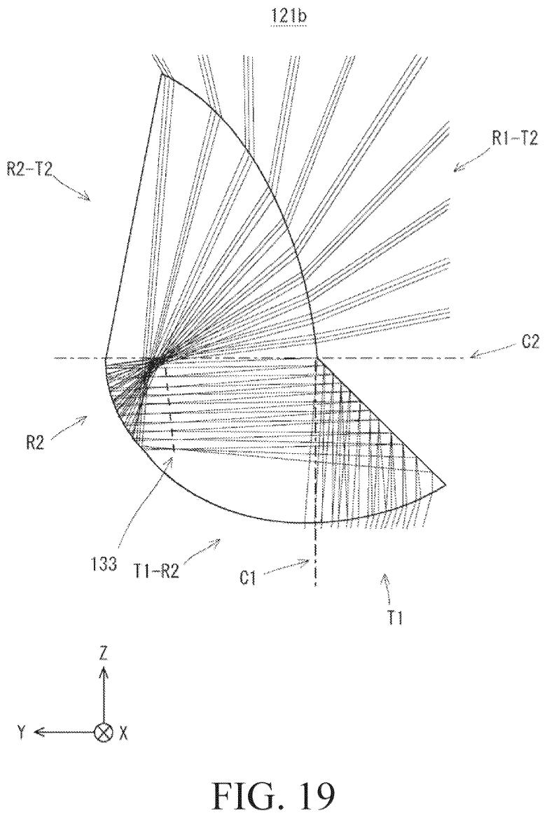

Next, an optical system according to another embodiment will be described. This embodiment is an example in which an ultra-wide-angle projection optical system is formed, but the size of the optical system is small. FIG. 18 is a cross-sectional view showing an example of an optical system 400 according to the fourth embodiment. FIG. 19 is a cross-sectional view showing an example of a second optical system 120c in the optical system 400 according to the fourth embodiment. In FIGS. 18 and 19, as an angle of view, projected light beams from 11° to 120° are shown.

As shown in FIGS. 18 and 19, the optical system 400 includes a first optical system 110c and a second optical system 120c. The configuration of a first transmission surface T1, a first reflection surface R1, a second reflection surface R2, and a second transmission surface T2 of the second optical system 120c may be the same as that in FIG. 1. Further, in the second optical system 120c, the exit pupil of the second optical system 120c is positioned at a position shorter than the focal point of the second transmission surface T2 as in the third embodiment of FIG. 13. Although the connection surface between the first transmission surface T1 and the first reflection surface R1 is not shown in the drawing, the first transmission surface T1 and the first reflection surface R1 may be extended and connected to each other, or may be connected to each other by a planar surface or a curved surface.

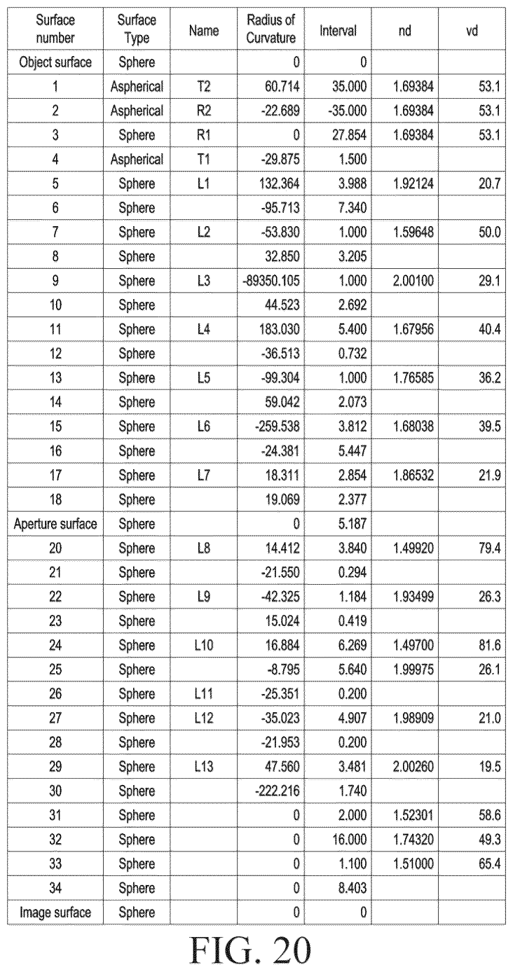

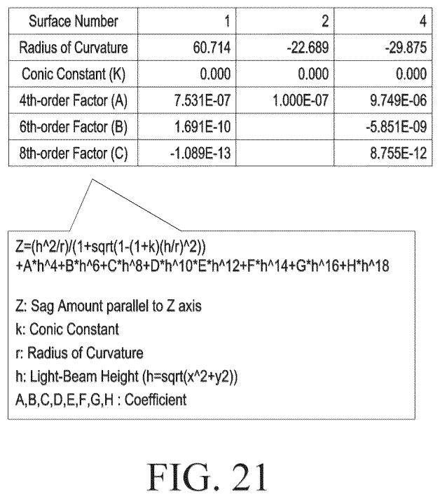

FIGS. 20 and 21 show examples of lens data of the optical system 400 in FIG. 18. FIG. 20 shows a surface type, a name, a radius of curvature, an interval, nd, and νd for the surface of each of optical members indicated by surface numbers from the image surface, which is the image display surface of the image display element 130, to the object surface, which is the projection surface 140. FIG. 21 shows design data of the aspheric surface of each of optical members indicated by surface numbers. The specification is the same as that in the embodiment of FIG. 13.

According to this embodiment, it is possible to provide an optical system 400 which is an ultra-wide-angle projection optical system and has a relatively small size. The rest of the configuration and effects have already been described in the descriptions of the first to third embodiments.

The present disclosure is not limited to the above-described embodiments, and they may be modified as appropriate without departing from the scope and spirit of the disclosure. For example, the configurations of the first to fourth embodiments may be combined with one another.

The embodiments may be combined as desirable by one of ordinary skill in the art.

While embodiments have been described with reference to the figures, it will be understood by those of ordinary skill in the art that various changes in form and details may be made therein without departing from the spirit and scope as defined by the following claims and their equivalents.

What is claimed is:

1. An optical system comprising:
an image display element;
a first optical system comprising a plurality of lenses; and
a second optical system comprising an optical element comprising a transmission surface and a reflection surface,
wherein the first optical system is configured to form an intermediate image from an image that is output from the image display element and passed through the first optical system, and
wherein the second optical system is configured to form an enlarged image of the intermediate image on a projection surface which is a conjugate plane of the image display element, the transmission surface of the optical element comprising a first transmission surface and a second transmission surface,
wherein the reflection surface comprises a first reflection surface and a second reflection surface,
wherein the first transmission surface, the first reflection surface, the second reflection surface, and the second transmission surface are arranged in an order in which light of the image from the first optical system passes through,
wherein an optical path between two adjacent surfaces of the first transmission surface, the first reflection surface, the second reflection surface, and the second transmission surface is formed of an optically transparent medium, and
wherein the second reflection surface has a concave shape.

2. The optical system according to claim 1, wherein the first reflection surface and the second transmission surface are seamlessly connected to each other.

3. The optical system according to claim 1, wherein the first reflection surface and the second transmission surface form a continuous surface, and
wherein a first reflection surface area and a second reflection area are separated, the first reflection surface area corresponding to a light-beam effective area of the first reflection surface and comprising a reflecting film, and the second transmission surface area corresponding to a light-beam effective area of the second transmission surface.

4. The optical system according to claim 1, wherein the first reflection surface has a planar shape.

5. The optical system according to claim 1, wherein the first transmission surface comprises a rotationally symmetric surface which is rotationally symmetric with respect to a first optical axis, the first optical axis being an optical axis of the first optical system.

6. The optical system according to claim 1, wherein the first reflection surface is configured to bend an optical axis of the first optical system by 90°.

7. The optical system according to claim 1, wherein the second reflection surface and the second transmission surface comprise a rotationally symmetric surface which is rotationally symmetric with respect to a second optical axis obtained by bending an optical axis of the first optical system by 90°.

8. The optical system according to claim 1, wherein the intermediate image is formed in an optical path between the first reflection surface and the second reflection surface.

9. An image projection apparatus comprising:
an optical system comprising:
an image display element;
a first optical system comprising a plurality of lenses; and
a second optical system comprising an optical element comprising a transmission surface and a reflection surface,
wherein the first optical system is configured to form an intermediate image from an image that is output from the image display element and passed through the first optical system, and
wherein the second optical system is configured to form an enlarged image of the intermediate image on a projection surface which is a conjugate plane of the image display element, the transmission surface of the optical element comprising a first transmission surface and a second transmission surface,
wherein the reflection surface comprises a first reflection surface and a second reflection surface,
wherein the first transmission surface, the first reflection surface, the second reflection surface, and the second transmission surface are provided in an order in which light of the image from the first optical system is configured to pass through,
wherein an optical path between two adjacent surfaces of the first transmission surface, the first reflection surface, the second reflection surface, and the second transmission surface is formed of an optically transparent medium, and
wherein the second reflection surface has a concave shape.

10. The optical system according to claim 9, wherein the first reflection surface and the second transmission surface form a continuous surface, and
wherein a first reflection surface area corresponding to a light-beam effective area of the first reflection surface and comprising a reflecting film, and a second transmission surface area corresponding to a light-beam effective area of the second transmission surface are separated.

11. The optical system according to claim 9, wherein the first reflection surface has a planar shape.

12. The optical system according to claim 9, wherein the first transmission surface comprises a rotationally symmetric surface which is rotationally symmetric with respect to a first optical axis, the first optical axis being an optical axis of the first optical system.

13. The optical system according to claim 9, wherein the first reflection surface is configured to bend an optical axis of the first optical system by 90°.

14. The optical system according to claim 9, wherein the second reflection surface and the second transmission surface comprise a rotationally symmetric surface which is rotationally symmetric with respect to a second optical axis obtained by bending an optical axis of the first optical system by 90°.

15. The optical system according to claim 9, wherein the intermediate image is configured to be formed in an optical path between the first reflection surface and the second reflection surface.
